(19) United States
(12) Patent Application Publication
(10) Pub. No.: US 2018/0052947 A1
(43) Pub. Date: Feb. 22, 2018

(54) LATTICE STRUCTURE REPRESENTATION FOR A THREE-DIMENSIONAL OBJECT

(71) Applicant: Hewlett-Packard Development Company, L.P., Houston, TX (US)

(72) Inventors: Juan Manuel GARCIA-REYERO VINAS, Sant Cugat del Valles (ES); Jan MOROVIC, Colchester (GB); Peter MOROVIC, Sant Cugat del Valles (ES); Alejandro Manuel DE PENA, Sant Cugat del Valles (ES)

(73) Assignee: Hewlett-Packard Development Company, L.P., Houston, TX (US)

(21) Appl. No.: 15/544,507

(22) PCT Filed: Apr. 23, 2015
(86) PCT No.: PCT/EP2015/058862

§ 371 Date: Jul. 18, 2017

(51) Int. Cl. G06F 17/50; B33Y 50/00; B29C 64/386

(52) U.S. Cl. CPC G06F 17/50; B29C 64/386; B33Y 50/00

(57) ABSTRACT

Certain described examples relate to the generation of data for use in producing a three-dimensional object. Certain examples utilize lattice indexes to define a lattice associated with a particular portion of the three dimensional object. The lattice index may be used in a matrix generation operation that compares index values with threshold values to generate a three-dimensional lattice matrix. The three-dimensional lattice matrix is useable to instruct a structure of the three-dimensional object.

### BACKGROUND

Apparatus that generate three-dimensional objects, including those commonly referred to as “3D printers”, have been proposed as a potentially convenient way to produce three-dimensional objects. These apparatus typically receive a definition of the three-dimensional object in the form of an object model. This object model is processed to instruct the apparatus to produce the object using one or more production materials. These production materials may comprise a combination of agents and powdered substrates, heated polymers and/or liquid solutions of production material. The processing of an object model may be performed on a layer-by-layer basis. It may be desired to produce a three-dimensional object with one or more properties, such as color, mechanical and/or structural properties. The processing of the object model may vary based on the type of apparatus and/or the production technology being implemented. Generating objects in three-dimensions presents many challenges that are not present with two-dimensional print apparatus.

### BRIEF DESCRIPTION OF THE DRAWINGS

Various features of the present disclosure will be apparent from the detailed description which follows, taken in conjunction with the accompanying drawings, which together illustrate, by way of example, features of the present disclosure, and wherein:

FIG. 1 is a schematic diagram showing an apparatus for generating object data representing a three-dimensional object according to an example;

FIG. 2 is a schematic diagram showing an apparatus for generating material formation instructions for a three-dimensional object according to an example;

FIG. 3 is a schematic diagram showing an apparatus for production of a three-dimensional object according to an example;

FIG. 4 is a flow diagram showing a method for generating object data representative of a three-dimensional object; and

FIG. 5 is a flow diagram showing a method for generating manufacture instructions for use by an additive manufacturing system to manufacture a three-dimensional object.

### DETAILED DESCRIPTION

In the production of three-dimensional objects, e.g. in so-called “3D printing”, there is a challenge to represent a three-dimensional object by an object model in a data efficient manner. Raster-based formats, which represent a three-dimensional object as a series of unit volumes referred to herein as “voxels”, in a similar manner to the way in which a two-dimensional image is divided into unit area referred to as “pixels”, require a large amount of data. Given this, a three-dimensional object is often represented in a vector-based format, e.g. data from a STereoLithography “.stl” file. Vector-based formats represent a three-dimensional object using defined model geometry, such as meshes or polygons and/or combinations of three-dimensional shape models. For example, a “.stl” file may comprise a vector representation in the form of a list of vertices in three dimensions, together with a surface tessellation in the form of a triangulation or association between three vertices.

The interior of a three-dimensional object encoded in a vector-based format is typically interpreted to be solid. A designer may, however, want to specify that the interior of part or all of a three-dimensional object have a lattice structure satisfying one or more conditions. For example, the designer may wish to specify a lattice size or shape to be applied to part or all of a model to control mechanical properties of the three-dimensional object. Such mechanical properties may include one or more of the tensile strength, weight, centre of gravity and metacentre. For example, centre of gravity and metacentre can be controlled by specifying different lattice densities for different parts of the three-dimensional object.

Certain examples described herein enable a designer to specify the internal structure, and including in some examples the surface structure, of a three-dimensional object in an object model in a data efficient manner. In particular, at least one lattice index can be included in the object model corresponding to a three-dimensional object, with each lattice index representative, in conjunction with an associated three-dimensional threshold matrix, a lattice structure for a corresponding volume of the three-dimensional object. The object model may also include a vector representation of the three-dimensional object.

Certain examples described herein enable a three-dimensional object with a desired structure to be produced. The term “lattice” as described herein refers to an arrangement of a production material within three-dimensions, e.g. this may be a regularly repeated arrangement of a particular sub-structure that makes up a three-dimensional object to be produced. This may cover arrangements that utilize tiling, repeated polyhedra and/or sub-structure repetitions that vary in at least one of density and frequency. In this manner, examples may include, amongst others: a regular crisscrossing of strips of material; (sub)-structure walls with varying thickness; and coil-type structures (including those of varying thickness and hence elasticity). Structures or sub-structures may be repeated in any direction in at least one of the three-dimensions. Frequency of repetition may vary in any direction in at least one of the three-dimensions.

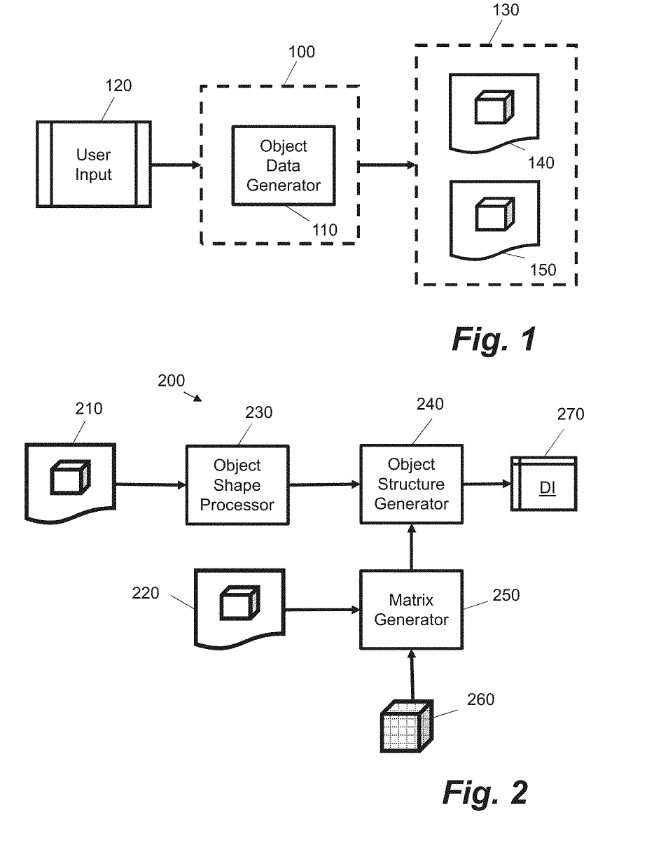

FIG. 1 shows an example of a computer system 100 to generate object data representative of a three-dimensional object. The computer system 100 includes object data generator 110 which processes user input 120 from a designer of the three-dimensional object to generate object data 130 representative of the three-dimensional object. In this example, the object data 130 includes a vector representation 140 of the three-dimensional object together with lattice index data 150 for the three-dimensional object. The lattice index data 150 stores a lattice index for each of one or more sub-volumes of the three-dimensional object. Each lattice index is associated with a three-dimensional threshold matrix.

A lattice structure can be represented by a three-dimensional matrix. A three-dimensional matrix can be represented by a group of two-dimensional lattices, each two-dimensional lattice representing a planar layer of the volume. For example, a simple cubic structure can be represented by:

| | | | | | | | |
|---|---|---|---|---|---|---|---|
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |
| 1 | 1 | 1 | 1 | 1 | 1 | 1 | 1 |
| 1 | 1 | 1 | 1 | 1 | 1 | 1 | 1 |
| 1 | 1 | 1 | 1 | 1 | 1 | 1 | 1 |
| 1 | 1 | 1 | 1 | 1 | 1 | 1 | 1 |
| 1 | 1 | 1 | 1 | 1 | 1 | 1 | 1 |
| 1 | 1 | 1 | 1 | 1 | 1 | 1 | 1 |
| 1 | 1 | 1 | 1 | 1 | 1 | 1 | 1 |
| 1 | 1 | 1 | 1 | 1 | 1 | 1 | 1 |

In the following description, for ease of explanation, simple cubic structures will be considered and the corresponding three-dimensional matrices will be represented by one of the repeating layers, this repeating layer being repeated seven times and capped with a full layer.

In an example, the three-dimensional threshold matrix is given by:

| | | | | | | | |
|---|---|---|---|---|---|---|---|
| 0 | 64 | 0 | 128 | 0 | 64 | 0 | 255 |
| 64 | 64 | 64 | 128 | 64 | 64 | 64 | 255 |
| 0 | 64 | 0 | 128 | 0 | 64 | 0 | 255 |
| 128 | 128 | 128 | 128 | 128 | 128 | 128 | 255 |
| 0 | 64 | 0 | 128 | 0 | 64 | 0 | 255 |
| 64 | 64 | 64 | 128 | 64 | 64 | 64 | 255 |
| 0 | 64 | 0 | 128 | 0 | 64 | 0 | 255 |
| 255 | 255 | 255 | 255 | 255 | 255 | 255 | 255 |

This three-dimensional threshold matrix corresponds to either a solid structure or one of three possible cubic structures, in dependence on the lattice index entered by the designer. In particular, each entry in the three-dimensional threshold matrix corresponds to a voxel, and the voxel is filled if the lattice index is smaller than or equal to the value of the entry. In this respect, the lattice index acts in an analogous manner to a halftone value.

Accordingly, if the lattice value is between 129 and 255, then the following three-dimensional lattice structure is provided:

| | | | | | | | |
|---|---|---|---|---|---|---|---|
| 0 | 0 | 0 | 0 | 0 | 0 | 0 | 1 |
| 0 | 0 | 0 | 0 | 0 | 0 | 0 | 1 |
| 0 | 0 | 0 | 0 | 0 | 0 | 0 | 1 |
| 0 | 0 | 0 | 0 | 0 | 0 | 0 | 1 |
| 0 | 0 | 0 | 0 | 0 | 0 | 0 | 1 |
| 0 | 0 | 0 | 0 | 0 | 0 | 0 | 1 |
| 0 | 0 | 0 | 0 | 0 | 0 | 0 | 1 |
| 1 | 1 | 1 | 1 | 1 | 1 | 1 | 1 |

If the lattice value is between 65 and 128, the following three-dimensional lattice structure is provided in which the cell dimensions in the plane of the two-dimensional repeating lattice is halved in comparison to a lattice value between 129 and 255:

| | | | | | | | |
|---|---|---|---|---|---|---|---|
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |
| 0 | 0 | 0 | 1 | 0 | 0 | 0 | 1 |
| 0 | 0 | 0 | 1 | 0 | 0 | 0 | 1 |
| 0 | 0 | 0 | 1 | 0 | 0 | 0 | 1 |
| 1 | 1 | 1 | 1 | 1 | 1 | 1 | 1 |

If the lattice value is between 1 and 64, the following three-dimensional lattice structure is provided in which the cell dimensions in the plane of the two-dimensional repeating lattice is halved in comparison with a lattice value between 65 and 128.

| | | | | | | | |
|---|---|---|---|---|---|---|---|
| 0 | 1 | 0 | 1 | 0 | 1 | 0 | 1 |
| 1 | 1 | 1 | 1 | 1 | 1 | 1 | 1 |
| 0 | 1 | 0 | 1 | 0 | 1 | 0 | 1 |
| 1 | 1 | 1 | 1 | 1 | 1 | 1 | 1 |
| 0 | 1 | 0 | 1 | 0 | 1 | 0 | 1 |
| 1 | 1 | 1 | 1 | 1 | 1 | 1 | 1 |
| 0 | 1 | 0 | 1 | 0 | 1 | 0 | 1 |
| 1 | 1 | 1 | 1 | 1 | 1 | 1 | 1 |

A lattice index equal to 0 would correspond to all voxels being filled, i.e. a solid structure.

As set out above, by using a three-dimensional threshold matrix, lattices with different cell sizes can be represented by different lattice indices. This provides a data efficient way of storing the internal structure of a three-dimensional object. Further, the processing time to process the lattice indices and three-dimensional threshold lattices is short.

In the above examples, a voxel is filled if the value of the corresponding lattice index is smaller than or equal to the value of the corresponding matrix element of the three-dimensional threshold matrix. Other examples may use different comparisons between the values of lattice indices and matrix elements of the three-dimensional threshold matrix. For example, a voxel may be filled if the corresponding lattice index is greater than or equal to the corresponding matrix element.

In other examples, different three-dimensional threshold matrices can be used to allow lattice parameters other than cell size to be specified by the designer by a lattice index. For example, the following three-dimensional threshold matrix can be used when specifying the thickness of a lattice wall:

| | | | | | | | |
|---|---|---|---|---|---|---|---|
| 0 | 32 | 64 | 128 | 255 | 128 | 64 | 32 |
| 32 | 32 | 64 | 128 | 255 | 128 | 64 | 32 |
| 64 | 64 | 64 | 128 | 255 | 128 | 64 | 64 |
| 128 | 128 | 128 | 128 | 255 | 128 | 128 | 128 |
| 255 | 255 | 255 | 255 | 255 | 255 | 255 | 255 |
| 128 | 128 | 128 | 128 | 255 | 128 | 128 | 128 |
| 64 | 64 | 64 | 128 | 255 | 128 | 64 | 64 |
| 32 | 32 | 64 | 128 | 255 | 128 | 64 | 32 |

In another example, the three-dimensional threshold matrix provides for rounding of the intersections between cell walls. In this way, the concentrations of stress that are present at intersections at sharp angles are alleviated. The following three-dimensional threshold matrix provides for such stress relief cells.

| | | | | | | | |
|---|---|---|---|---|---|---|---|
| 0 | 4 | 8 | 16 | 32 | 64 | 128 | 255 |
| 4 | 8 | 8 | 16 | 32 | 64 | 128 | 255 |
| 8 | 8 | 16 | 16 | 32 | 64 | 128 | 255 |
| 16 | 16 | 16 | 32 | 32 | 64 | 128 | 255 |
| 32 | 32 | 32 | 32 | 64 | 64 | 128 | 255 |
| 64 | 64 | 64 | 64 | 64 | 128 | 255 | 255 |
| 128 | 128 | 128 | 128 | 128 | 255 | 255 | 255 |
| 255 | 255 | 255 | 255 | 255 | 255 | 255 | 255 |

Each of the three-dimensional threshold matrices discussed above by way of example illustrates a corresponding lattice feature that can be specified by the designer of a three-dimensional object model. Other three-dimensional threshold matrices, particularly three-dimensional threshold matrices with larger dimensions, could allow a designer to specify combinations of these lattice features.

In an example, the object data generator 110 uses a single three-dimensional threshold matrix and the user input 120 from the designer indicates a lattice index for use with that three-dimensional threshold matrix. In another example, the object data generator 110 can use a plurality of different three-dimensional threshold matrices, the user input 120 includes both an indication of the lattice index and an indication of the three-dimensional threshold matrix, and the lattice index data 150 includes an indication of the three-dimensional threshold matrix or the three-dimensional threshold matrix itself.

The three-dimensional threshold matrices discussed above relate to simple cubic matrices for ease of representation. The three-dimensional threshold matrices could correspond to more complicated structures.

FIG. 2 schematically shows apparatus 200 for processing an object model such as that produced by the apparatus 100 discussed with reference to FIG. 1 to provide output instructions for an additive manufacturing system such as a “3D printer”. As shown, a vector representation 210 of a three-dimensional object, such as the vector representation 140, is process by an object shape processor 230 to generate three-dimensional shape data. Lattice index data 220, such as lattice index data 150, is separately input to a matrix generator 250 together with a three-dimensional threshold matrix 260. The three-dimensional threshold matrix may be a single available three-dimensional threshold matrix, one of a plurality of three-dimensional threshold matrices stored by the apparatus 200 selected in accordance with an indication provided in the lattice index data 220, or may be provided as part of the lattice index data 220.

The matrix generator 250 processes the three-dimensional threshold matrix and the lattice indices as discussed above to generate one or more three-dimensional lattice matrices for different part of the three dimensional object in the manner discussed above. An object structure generator 240 then processes the three-dimensional shape data in conjunction with the three-dimensional lattice matrices to generate the instructions 270 for the additive manufacturing system.

In one case, the apparatus 200 may be implemented as part of an additive manufacturing system, e.g. may comprise electronics or portions of an embedded controller for a “3D printer”. In another case, one or more portions of the apparatus 200 may be implemented using computer program code configured to be processed by one or more processors. These processors may form part of an additive manufacturing system (e.g. a computing module of a “3D printer”) and/or may form part of a computer device communicatively coupled to the additive manufacturing system (e.g. a desktop computer configured to control a “3D printer” and/or a “3D print driver” installed on the computer device). In one case, the computer device may comprise a server communicatively coupled to an additive manufacturing system; e.g. a user may submit the data 210,220 defining the three-dimensional object from a mobile computing device for processing by the apparatus 200 “in the cloud”, the apparatus 200 may then send the material formation instructions 270 to an additive manufacturing system via a network communications channel.

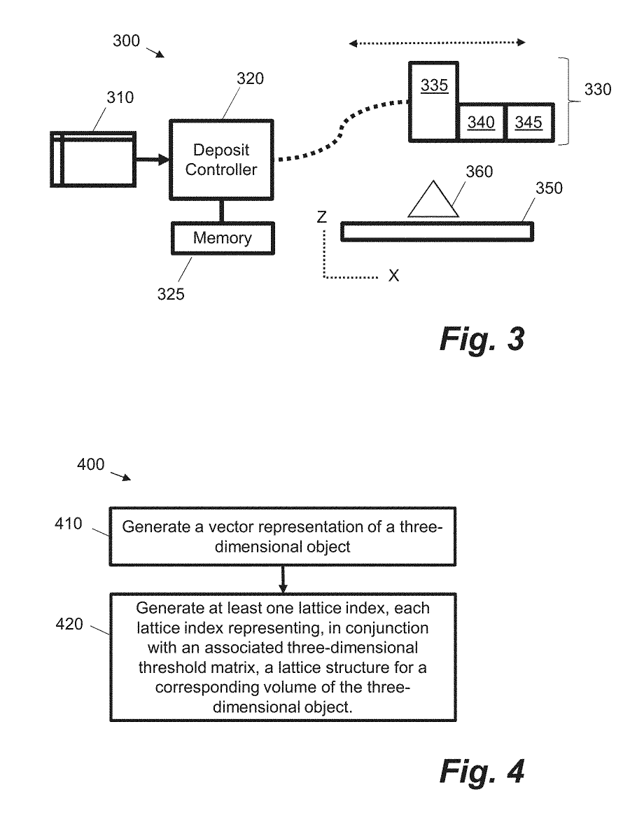

An example of an apparatus arranged to produce a three-dimensional object according to the material formation instructions 270 will now be described with reference to FIG. 3. FIG. 3 shows an example of an apparatus 300 arranged to produce a three-dimensional object 360. The apparatus 300 is arranged to receive data 310 for the three-dimensional object, which may comprise material formation instructions 270 as described above. Apparatus 300 is shown and described for better understanding of the presently described examples; other apparatus of a different form and/or using a different technology may alternatively be used with the structural volume coverage representations described herein.

In FIG. 3, the apparatus 300 comprises a deposit controller 320 and a memory 325. The deposit controller 320 may comprise one or more processors that form part of an embedded computing device, e.g. adapted for use in controlling an additive manufacturing system. Memory 325 may comprise volatile and/or non-volatile memory, e.g. a non-transitory storage medium, arranged to store computer program code, e.g. in the form of firmware. The deposit controller 320 is communicatively coupled to aspects of the apparatus that are arranged to construct the three dimensional object. These comprise a deposit mechanism 330. The deposit mechanism 330 is arranged to deposit production materials to generate the three-dimensional object. In the present case, the deposit mechanism comprises a substrate supply mechanism 335 and an agent ejection mechanism 340, 345. In other cases the deposit mechanism 330 may comprise fewer or additional components, e.g. a substrate supply mechanism may be provided separately from the agent ejection mechanism or omitted, or other components, e.g. the deposit mechanism 330 may comprise a polymer extraction mechanism. In the schematic example of FIG. 2, the agent ejection mechanism 340, 345 comprise two components: a first component 340 for the supply of a first agent and a second component 345 for the supply of a second agent. Two materials are presented in this example for ease of explanation but any number of materials may be supplied. Similar materials in the form of agents are described for example only. The substrate supply mechanism 335 is arranged to supply at least one substrate layer upon which the materials available for production are deposited by the agent ejection mechanism 340, 345 to produce the three-dimensional object 360. In the present case, the materials comprise agents that are applied to a powder substrate, wherein the combination of agent and powder, following a curing process, form part of the object. However, other implementations are possible, e.g. the materials may be deposited to form part of the object, e.g. as per the polymer case discussed above. In the example of FIG. 3, the three-dimensional object 360 is built layer by layer on a platen 350. The arrangement of the aspects and components shown in FIG. 3 are not limiting; the exact arrangement of each apparatus will vary according to the production technology that is implemented and the model of apparatus.

In the example of FIG. 3 the deposit controller 320 is configured to process and/or otherwise use the data 310 to control one or more components of the deposit mechanism 330. The deposit controller 320 may control one or more of the substrate supply mechanism 335 and the agent ejection mechanism 340, 345. For example, the discrete material formation instructions in the data 270 may be used by the deposit controller 320 to control nozzles within the agent ejection mechanism. In one implementation the apparatus 300 may be arranged to use a coalescing agent and a coalescing modifier agent that are respectively supplied by the components of the agent ejection mechanism 340, 345. These agents allow a three-dimensional object to have varying material properties. They may be combined with one or more colored powdered substrate materials, e.g. applied using an inkjet mechanism to deposited powder layers, to generate multi-color objects with varying material properties. In these cases the generated objects may be constructed by depositing at least the coalescing agent and the coalescing modifier agent on layers of substrate material, e.g. layers of powder or other material forming z-plane slices, followed by the application of energy to bind the material, e.g. infra-red or ultra-violet light. For example, one or more of the substrate supply mechanism 335 and the agent ejection mechanism 340, 345 may be moveable relative to the platen 350, e.g. in one or more of the x, y and z directions (wherein the y axis is into the sheet for FIG. 3). One or more of the substrate supply mechanism 335, the agent ejection mechanism 340, 345 and the platen 350 may be moveable under control of the deposit controller 320 to achieve this. Additionally, one or more inks may also be deposited on cured and/or uncured layers. In other implementations the apparatus may comprise part of, amongst others, selective laser sintering systems, stereo lithography systems, inkjet systems, fused deposition modelling systems, any three-dimensional printing system, inkjet deposition systems and laminated object manufacturing systems. These include apparatus that directly deposit materials rather than those described that use various agents.

In one case, the functionality of the apparatus 200 and the deposit controller 320 may be combined in one embedded system that is arranged to receive the data 210,220 defining the three-dimensional object, or data useable to produce this, and control the apparatus 300 accordingly. This may be the case for a “stand alone” apparatus that is arranged to receive data 210,220, e.g. by physical transfer and/or over a network, and produce an object. For example, this apparatus may be communicatively coupled to a computer device that is arranged to send a “print job” comprising the object definition 210,220, or data useable to produce the object definition 210, to the apparatus in the manner of a two-dimensional printer.

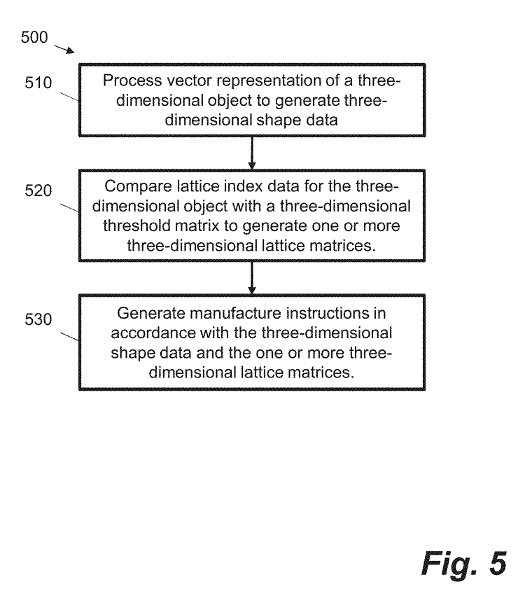

FIG. 4 shows a method 400 for generating object data representative of a three-dimensional object according to an example. This method may be applied by the apparatus 100. At block 410, a vector representation of a three-dimensional object is generated. At block 420, at least one lattice index is generated. Each lattice index is representative, in conjunction with an associated three-dimensional threshold matrix, of a lattice structure for a corresponding volume or sub-volume of the three-dimensional object. The object data comprises the vector representation of the three-dimensional object and the at least one lattice index.

FIG. 5 shows a method for generating manufacturing instructions for use within an additive manufacturing system. This method may be applied by the apparatus 200 and deposit controller 320, by another additive manufacturing system or by a computer device arranged to control an additive manufacturing system. At block 510, a vector representation of a three-dimensional object is processed to generate three-dimensional shape data. At block 520, lattice index data for the three-dimensional object is compared with a three-dimensional threshold matrix to generate one or more three-dimensional lattice matrices. At block 530, manufacture instructions are generated in accordance with the three-dimensional shape data and the one or more three-dimensional lattice matrices.

Certain system components and methods described herein may be implemented by way of computer program code that is storable on a non-transitory storage medium. The computer program code may be implemented by a control system comprising at least one processor that is arranged to retrieve data from a computer-readable storage medium. The control system may comprise part of an object production system such as an additive manufacturing system. The computer-readable storage medium may comprise a set of computer-readable instructions stored thereon. The at least one processor may be configured to load the instructions into memory for processing. The instructions are arranged to cause the at least one processor to perform a series of actions. The instructions may instruct the method 500 of FIG. 5 and/or any other of the blocks or processes described herein. The non-transitory storage medium can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

The preceding description has been presented to illustrate and describe examples of the principles described. This description is not intended to be exhaustive or to limit these principles to any precise form disclosed. Many modifications and variations are possible in light of the above teaching. Techniques, functions and approaches described in relation to one example may be used in other described examples, e.g. by applying relevant portions of that disclosure.

What is claimed is:

1. An apparatus arranged to generate control data for production of a three-dimensional object comprising:
a data interface to receive object data representative of a three-dimensional object, the object data comprising at least one lattice index, each of the at least one lattice indices specifying a lattice parameter for at least one respective volume of the three-dimensional object; and
a matrix generator to generate, for each of the at least one respective volumes, a three-dimensional lattice matrix by comparing the magnitude of the corresponding lattice index to the respective magnitudes of values of matrix elements of a three-dimensional threshold matrix, wherein the three-dimensional lattice matrix represents a structure for the corresponding volume.

2. The apparatus according to claim 1, wherein the three-dimensional threshold matrix corresponds to a plurality of possible lattice structures, each of the lattice structures having at least one different dimension, and
wherein the lattice index for a volume of the three-dimensional object is representative of the value of said at least one dimension for the volume.

3. The apparatus according to claim 2, wherein each of the plurality of possible lattice structures has a respective different cell size, and wherein the lattice index for a volume is representative of the cell size in that volume.

4. The apparatus according to claim 2, wherein each of the plurality of possible lattice structures has a respective different wall thickness, and wherein the lattice index for a volume is representative of the wall thickness in that volume.

5. The apparatus according to claim 1, wherein the matrix elements of the three-dimensional threshold matrix have values to provide stress-relief for at least one structure represented by an index value.

6. The apparatus according to claim 1, wherein the object data further comprises a vector representation of the three-dimensional object.

7. The apparatus according to claim 1, wherein the object data further comprises the three-dimensional threshold matrix or data indicative of the three-dimensional threshold matrix.

8. A method for generating object data representative of a three-dimensional object, the method comprising:
generating a vector representation of the three-dimensional object; and
generating at least one lattice index, each lattice index representing, in conjunction with an associated three-dimensional threshold matrix, a lattice structure for a corresponding volume of the three-dimensional object,
wherein the object data comprises the vector representation of the three-dimensional object and the at least one lattice index.

9. The method according to claim 8, wherein the three-dimensional threshold matrix corresponds to a plurality of possible lattice structures, each of the lattice structures having at least one different dimension, and
wherein the lattice index for a volume of the three-dimensional object is representative of the value of said at least one dimension for the volume.

10. The method according to claim 9, wherein each of the plurality of possible lattice structures has a respective different cell size, and wherein the lattice index for a volume is representative of the cell size in that volume.

11. The method according to claim 9, wherein each of the plurality of possible lattice structures has a respective different wall thickness, and wherein the lattice index for a volume is representative of the wall thickness in that volume.

12. The method according to claim 8, wherein the matrix elements of the three-dimensional threshold matrix have values to provide stress-relief for at least one structure represented by an index value.

13. The method of claim 8, wherein the object data further comprises the three-dimensional threshold matrix or data indicative of the three-dimensional threshold matrix.

14. The method of claim 8, wherein the lattice structure comprises a regular repeated sub-structure.

15. An electronic data structure comprising object data representative of a three-dimensional object, the electronic data structure comprising:
a vector representation of the three-dimensional object; and
at least one lattice index in association with a corresponding volume of the three-dimensional object, each of the at least one lattice indices representing, in conjunction with an associated three-dimensional threshold matrix, a lattice structure for the corresponding volume of the three-dimensional object.
